(19) United States
(12) Patent Application Publication
(10) Pub. No.: US 2009/0232707 A1
(43) Pub. Date: Sep. 17, 2009

(54) Apparatus for examining bodily fluids

(76) Inventor: Holger Behnk, Hamburg (DE)

Correspondence Address: ALIX YALE & RISTAS LLP, 750 MAIN STREET, SUITE 1400, HARTFORD, CT, 06103, US

(21) Appl. No.: 12/075,512

(22) Filed: Mar. 11, 2008

(51) Int. Cl. B01L 3/00

(52) U.S. Cl. 422/102

(57) ABSTRACT

The apparatus for examining bodily fluids comprising a plurality of cuvettes into which bodily fluid and a reagent can be introduced is distinguished by the apparatus comprising chambers that are open at the top, the number of said chambers being at least equal to the number of the cuvettes.

### BACKGROUND

The invention relates to an apparatus for examining bodily fluids comprising a plurality of cuvettes into which bodily fluid and a reagent can be introduced into cavities provided therefor.

Bodily fluids that are to be examined are delivered to the laboratory in glass tubes which are sealed by a stopper. For reasons of hygiene and to avoid the spread of disease and contamination of the bodily fluid, it is desirable in this case to extract the bodily fluid without removing the stopper. For this purpose, it is known to pierce the stopper with a needle similar to an injection needle and then suck out the desired amount of fluid.

The problem in this case is that the stopper must seal the glass tube in an airtight fashion. Hence there is excess or reduced pressure in the glass tube, the magnitude of which is unknown. The amount of bodily fluid removed is less or more than desired, depending on the interior pressure of the glass tube. It is quite clear that because of this the measurement results are falsified since the reaction speed between bodily fluid and reagent naturally depends on the mixing ratio of the two.

It is known to provide the needle with grooves, which extend in the longitudinal direction, on its exterior circumference, so that when the needle is pierced into the stopper, air channels remain between needle and stopper. However, the corresponding pressure balance may not be achieved anyhow, since the soft material of the stopper can clog the air channels. Furthermore, due to the grooves, the needle will have a larger diameter, so that it becomes more difficult to push it through the stopper. It is also known to provide closed air channels instead of the grooves, which makes the manufacture of the needle very complex. Self-evidently, such a needle must also have a larger diameter, which entails the disadvantage mentioned above. Furthermore, the lateral pressure balance channel is closed when the needle is pulled out, so that low pressure is generated and when the needle is then pulled out further, a part of the fluid contained in the tube is sucked out of the needle again. This problem also occurs in a further, previously known system in which two needles are used, specifically where one needle is used to suck out the fluid and a further needle has the channel for pressure balance. In this case too, greater forces again have to be applied to push the needles through the stopper than would be the case with one needle.

### SUMMARY

An apparatus of the type mentioned initially is provided with the aid of which exactly defined amounts of the bodily fluid can be examined, even in the case of glass tubes sealed with stoppers. The same accuracy is thus to be obtained as in the case of sample tubes which have not been sealed by stoppers.

The apparatus comprises chambers that are open at the top in addition to the cavities of the cuvettes and outside of the same, the number of said chambers being at least equal to the number of the cuvettes.

The apparatus makes the following modus operandi possible. First an amount of fluid which is greater than required for the measurement is removed using a needle which requires no grooves or channels for pressure balance. This amount of fluid is then placed into one of the chambers. These chambers are arranged outside of the cuvettes and have no fluid connection to the cavities of the cuvettes. Here, “outside of the cuvettes” is also intended to include the case where the chambers are integrally formed with the cuvettes, but are separate from the measurement and reaction cavities of the cuvettes. From these chambers the fluid can then be placed into the cavities of the cuvettes without excess pressure and hence metered exactly. Hence, an exact dose and thus measurement are possible, without substantial expenditure being required in the manufacturing of the apparatus. It is thus readily possible to arrange the chambers between the cuvettes and, for example, to manufacture the chambers integrally with the holder of the cuvettes, for instance by injection molding. Hence there are no major additional costs. Furthermore, the chambers do not have to be kept sterile separately or be disposed of separately. Rather, they are handled together with the cuvettes.

Expediently, the number of the open chambers is equal to the number of cuvettes. In this case, the open chambers are expediently arranged between the cuvettes since this only takes up little additional space. It has proven to be particularly expedient for the open chambers to be arranged next to each other in the center of the apparatus and between two cuvettes.

The apparatus is suited to various examinations of bodily fluids. In this context, a particularly advantageous but not exclusive application is the measurement of the blood clotting time. A method and an apparatus to examine and measure the blood clotting time to which the invention can be applied are disclosed in EP 0 369 168 B1, the contents of which are herewith incorporated as a disclosure.

This method is distinguished by the fact that blood plasma and reagent are placed next to each other on an essentially horizontal inner face of a measurement cuvette which is provided with a opening above this face, that the measurement cuvette and its contents are heated to the reaction temperature, that the measurement cuvette in the measurement station is pivoted through substantially 90° in such a way that the inner face is essentially vertical and the plasma and reagent are confluent, and that the measurement is subsequently carried out.

Hence blood plasma and reagent are applied next to each other onto a substantially horizontal face; in this case they at first still have a temperature of, for example, 15° C., at which no reactions take place yet. Subsequently the measurement cuvette and its contents are then heated to the reaction temperature, with no reaction yet taking place between the plasma and reagent, since the two fluids are arranged next to each other and have not yet intermixed. Subsequently the measurement cuvette is then pivoted through substantially 90° in such a way that the inner face is essentially vertical, as a result of which the plasma and reagent are confluent. Subsequently the measurement can then be carried out.

In this case, the measurement is carried out by a stirring element which can be attracted magnetically. If the inner face of the cuvette is initially tilted by a few degrees, so that the end area of the inner face which is to be pivoted upward during pivoting lies lower than the remaining areas of the inner face, then the stirring element can initially be arranged in this lower area. In the process, the cuvette can initially be tilted and then the stirring element be positioned in the lower-lying area or else the stirring element can be positioned first in such a way that it rolls to the desired place during the subsequent tilting. The stirring element then falls into the reagent at the beginning of the pivoting procedure and then into the plasma and drags these down with it, which results in better mixing being achieved right from the outset. At the same time, the stirring element ensures a constant speed during the transport of the reagent.

In other embodiments the tilting will be chosen in the exact opposite sense, so that the stirring element does not fall through the fluids during the pivoting, which could lead to splashes and undesired dispersing of the fluids.

It has found to be particularly expedient for the stirring element to be a metal sphere.

If the measurement cuvette is allowed to fall a restricted amount and hit an impact area after pivoting, then the stirring element and fluids are impulsively moved downward, so that maximal amounts of the fluids are quickly available here and can be intermixed.

It is thus readily possible to design the method in the form of an assembly line in such a way that a plurality of measurement cuvettes are simultaneously led through the individual stations in successive order and are subsequently disposed of.

In particular, this is possible in the case of a measurement cuvette for examining and measuring the blood clotting time comprising an inner face which is arranged substantially horizontally, an opening above this inner face, and a surface structure which prevent the confluence of the fluids and which cuvette is distinguished by comprising a stirring element which can be magnetically attracted and by a plurality of measurement cuvettes being arranged in a holder which comprises a toothed rack.

If a plurality of measurement cuvettes are arranged in a common holder comprising a toothed rack, then this plurality of measurement cuvettes can be led through different stations by a gearwheel drive. In this manner, a large number of examinations can be carried out in quick succession in a very efficient manner.

Since the inner face is to be arranged substantially horizontally, particularly large amounts of plasma can be arranged next to each other in the reagent, said plasma being prevented from being confluent in this position of the measurement cuvette by the surface structures. If the measurement cuvettes are subsequently pivoted, in particular by approximately 95°, so that they are then vertical, these surface structures can no longer prevent confluence. This holds in particular if the cuvette is in addition allowed to drop onto an impact area after pivoting, in which context a distance of as little as 5 mm is sufficient.

The surface structures can be small well-shaped depressions for the fluids.

Expediently, areas separated from one another by an intermediary surface are delimited by the surface structures. Initially in the process, the fluids remain in the surface areas and are separated from one another by the intermediary surface. The surface structures can be linear, burr-like projections. However, the surface structures can be manufactured particularly easily if they are linear notches.

If the inner face is delimited in the initially lower-lying area at its border by two delimiting walls which meet in the center at an obtuse angle, then a spherical stirring element will automatically roll into the center of the edge at the start such that it then falls through the fluid drops from this center and thus carries a particularly large amount of fluid into the area in which the subsequent measurement is to be carried out. On the face onto which the stirring element and the fluids impact, a central cylindrical depression is expediently provided, such that the spherical stirring element can perform circular motion here which is effected by the magnet stirring device.

Expediently it is provided that the border areas arranged outside the cylindrical recess are slanted inwardly and slanted downwardly in the position after pivoting, these end areas at least partly having a smaller thickness than the diameter of the sphere. By means of these slanted areas, in particular slanted in the form of a spherical shell, it is ensured that the sphere rapidly reaches the provided cylindrical path even if it impacts on the border areas. If the end areas have a smaller thickness than the diameter of the sphere, then not only is the fluid material in the cylindrical area stirred by the sphere; rather those fluid parts which are located in the border areas, in particular in the corners of a rectangular measurement cuvette, are also stirred.

As previously mentioned, the method and apparatus have the advantage that a very large number of different measurements, specifically up to 13 determinations, are possible at the same time. It is easily possible to store the corresponding 13 reagents in a cooled state and make a complete coagulation status at any time. Whereas previously known devices have three pumps, for example for the basic determination of the PT (prothrombin time) and PTT (partial thrombin time), which for a long time sufficed for the coagulation status, it is now also possible to additionally measure TT (thrombin time) and fibrinogen, which already occurs in a number of hospitals. This can not be measured in one pass per patient in any previously known appliance. If errors occur in this coagulation status, these factors can and must be additionally measured. This then adds up to the total of 13 determinations mentioned above.

### BRIEF DESCRIPTION OF THE DRAWINGS

FIG. 1 shows an embodiment in a perspective illustration;

FIG. 2 shows the embodiment from FIG. 1 in a plan view;

FIG. 3 shows the principle of use of measurement cuvettes which can be used;

FIG. 4 shows the measurement cuvette in the lying state in a plan view;

FIG. 5 shows the same measurement cuvette in an end view;

FIG. 6 shows the measurement cuvette in the measurement station, wherein the measurement cuvette is shown rotated through 90° about its longitudinal axis compared to the illustration of FIG. 4; and

FIG. 7 shows a number of measurement cuvettes which are collectively assembled in a common holder comprising a toothed rack.

### DETAILED DESCRIPTION

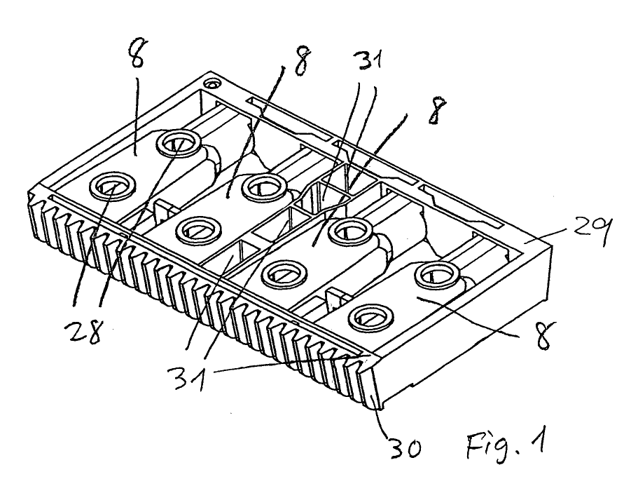

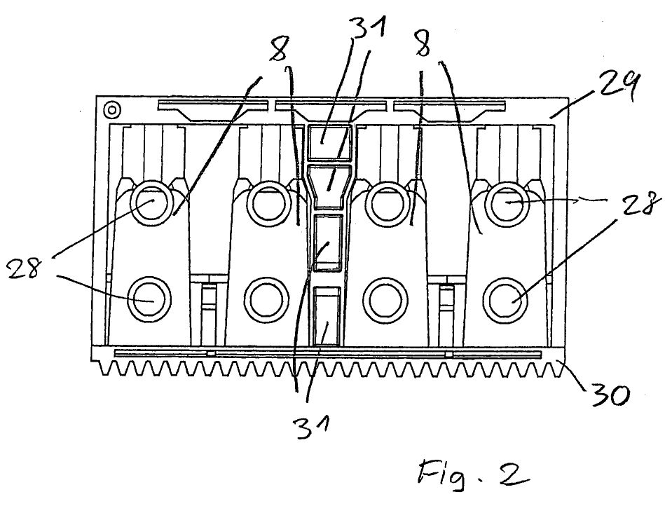

The embodiment shown in FIGS. 1 and 2 comprises a plurality of cuvettes 8 which are provided with openings 28 through which bodily fluid and reagent can be inserted. In this case, the cuvettes 8 are arranged in a holder 29 which comprises a toothed rack 30, with the aid of which rack the apparatuses can be moved through measurement equipment. Between the two central cuvettes 8, the holder 29 comprises a web in which chambers 31 that are open at the top are arranged. First, a larger amount of bodily fluid is inserted into these chambers than is required for the measurement. Subsequently, the required amount is then removed from the corresponding chamber 31 and inserted into the opening 28 of the corresponding cuvette 8 without problems occurring due to pressure differentials.

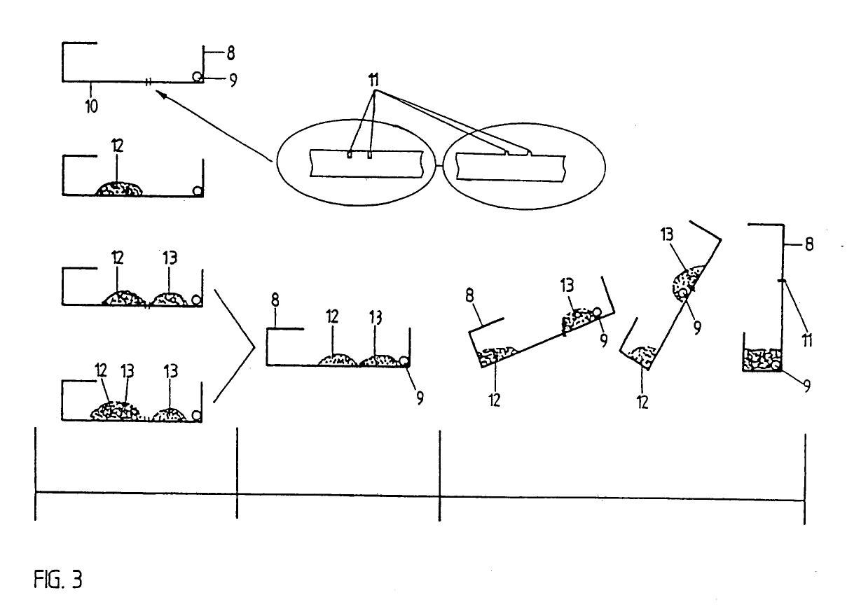

On the basis of FIGS. 3 to 7, a particularly advantageous embodiment is to be described below. In this case, the procedure shown in FIG. 3, which can be carried out with the apparatuses, is explained first of all.

The measurement cuvette 8 is essentially cuboidal and has an opening in one of its faces, said opening occupying a significant part of these faces. Thus, the measurement cuvette 8 has a shape similar to that of a shoe. In step 6, the stirring element 9 in the form of a sphere is first of all inserted. In this case, the measurement cuvette 8 is slightly tilted, namely such that the sphere 9 is located at the lowest position. This tilt of the cuvette 8 is not necessarily required and thus not illustrated in FIG. 3. In the center, the lower face 10 of the cuvette 8 is subdivided by scored depressions 11 or burr-like projections, which will be explained in more detail in connection with FIG. 4. These depressions or projections 11 are also shown magnified in FIG. 3. The plasma 12 is introduced on the left of the scores 11. Subsequently (in the illustration of FIG. 3 from top to bottom) a reagent 13 is introduced to the right of the plasma 12 and the scores 11. If required, an additional reagent can subsequently be supplied to the plasma 12.

The measurement cuvette 8 is brought to a further station in this state and is incubated at a temperature of 37° C. in step 7. When the desired temperature is reached, the cuvette 8 is then tilted in step 3, that is to say in the measurement station. As can be seen in the central part at step 3, the sphere 9 in this case enters the reagent 13 and carries it with it such that, in the right-hand position, the sphere 9 is located at the bottom and plasma and reagent have been mixed in the process. Here the measurement of the clotting time is then carried out.

The cuvette 8 is shown in more detail in a plan view in FIG. 4. There, in the position of step 6 and 7 in FIG. 3, bottom face 10 onto which plasma 12 and reagent 13 are applied is provided with notches, which are at right angles to one another and, at least in FIG. 4, delimit an enclosed surface in the upper area. The two areas, which are at least partly encircled by the notches 11, are separated by an intermediary region 14, so that the fluids, whose flow is obstructed by the notches 11, are clearly separated from one another, as long as the measurement cuvette 8 is in its substantially horizontal position.

The side walls 15 and 16 are closed, as are the end faces 17 and 18. A part of the upper face is closed by a cover 19.

At the top of FIG. 4, the base face 10 is delimited by slanted faces 20, so that the sphere 9 is arranged in the center of the face 10 when the cuvette 8 is tilted slightly lower in this area. The opposite end face 18 comprises a cylindrical recess 21, with the border areas 22 being slanted in the corners, as can also be seen from FIG. 4. FIG. 5 in this case shows the end face 18 in a plan view.

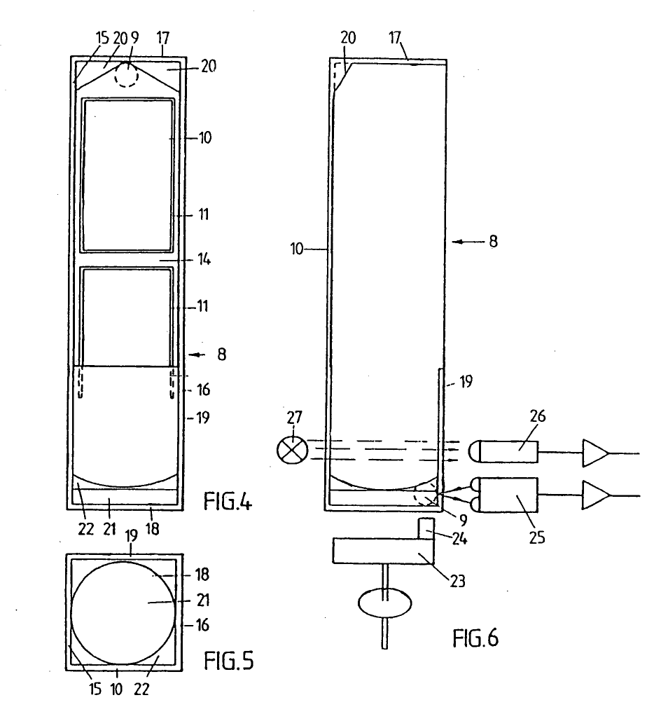

The slanted faces 22 have the effect that the sphere falls into the cylindrical recess 21 when the measurement cuvette 8 is pivoted into the vertical position of FIG. 6. In this case, the sphere 9 projects into the space above the cylindrical recess 21 so that all of the fluid contained in the lower area after pivoting is well mixed by it when it is moved by a magnetic stirrer 23 with a permanent magnet 24.

The onset of clotting can be determined by photoelectrical devices, which are illustrated schematically at 25 and 26. In this case, the device 25 is a reflection measuring device, while the device 26 with a light source 27 is a transmission measurement device. These measurement devices are known from the patent specifications mentioned initially, so it is not necessary to describe these here in any more detail. It is understood that the measurement cuvette 8 is transparent, so that the measurements can be carried out.

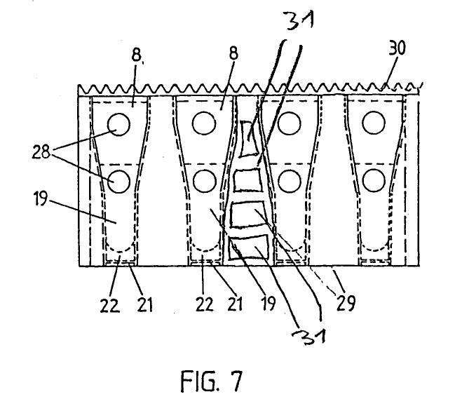

FIG. 7 shows that a row of measurement cuvettes 8 are arranged next to each other in a holder 29 which has a toothed rack 30 on its outside. With the aid of this toothed rack 30 and a gearwheel drive (not illustrated), the holder with the measurement cuvettes can be transported through the individual stations, so that a large number of examinations can be carried out in quick succession. In the embodiment shown in FIG. 7, the covering plate 19 also more or less covers the total area of the measurement cuvette 8; the covering plate 19 only has two openings 28 through which plasma, reagent and sphere can be introduced. At 31 the upwardly open chambers are shown in the center between two cuvettes 8.

1. An apparatus for examining bodily fluids comprising a plurality of cuvettes into which bodily fluid and a reagent can be introduced into cavities provided therefor, wherein the apparatus comprises chambers that are open at the top in addition to the cavities of the cuvettes and outside of the same, the number of said chambers being at least equal to the number of the cuvettes.

2. The apparatus as claimed in claim 1, wherein the number of the open chambers is equal to the number of cuvettes.

3. The apparatus as claimed in claim 1, wherein the open chambers are arranged between cuvettes.

4. The apparatus as claimed in claim 3, wherein the open chambers are arranged next to each other in the center of the apparatus and between two cuvettes.

5. The apparatus as claimed in claim 1, wherein the cuvettes comprise an inner face which is to be arranged substantially horizontally, at least one opening above this inner face, and surface structures which prevent the confluence of the bodily fluid and reagent and said cuvettes are arranged in a holder which comprises the chambers that are open at the top.

6. The apparatus as claimed in claim 5, wherein the cuvettes comprise a stirring element which can be attracted magnetically.

7. The apparatus as claimed in claim 5, wherein the surface structures are depressions or small well-shaped areas.

8. The apparatus as claimed in claim 5, wherein the surface structures are linearly shaped and areas separated from another by an intermediary surface are delimited by these structures.

9. The apparatus as claimed in claim 5, wherein the surface structures are linear projections.

10. The apparatus as claimed in claim 5, wherein the surface structures are linear notches.

11. The apparatus as claimed in claim 5, wherein the inner face is delimited in the initially lower-lying area at its border by two edges which meet in the center at an obtuse angle.

12. The apparatus as claimed in claim 11, wherein on the opposite side, the cuvette comprises a central cylindrical or oval depression on the end face which is perpendicular to the inner face and horizontal after pivoting.

13. The apparatus as claimed in claim 12, wherein the border areas arranged outside the cylindrical recesses are slanted inwardly and slanted downwardly in the position after pivoting, these end areas at least partly having a smaller thickness than the diameter of the stirring element.

14. The apparatus as claimed in claim 2, wherein the open chambers are arranged between cuvettes.

15. The apparatus as claimed in claim 2, wherein the cuvettes comprise an inner face which is to be arranged substantially horizontally, at least one opening above this inner face, and surface structures which prevent the confluence of the bodily fluid and reagent and said cuvettes are arranged in a holder which comprises the chambers that are open at the top.

16. The apparatus as claimed in claim 3, wherein the cuvettes comprise an inner face which is to be arranged substantially horizontally, at least one opening above this inner face, and surface structures which prevent the confluence of the bodily fluid and reagent and said cuvettes are arranged in a holder which comprises the chambers that are open at the top.

17. The apparatus as claimed in claim 4, wherein the cuvettes comprise an inner face which is to be arranged substantially horizontally, at least one opening above this inner face, and surface structures which prevent the confluence of the bodily fluid and reagent and said cuvettes are arranged in a holder which comprises the chambers that are open at the top.

18. The apparatus as claimed in claim 6, wherein the surface structures are depressions or small well-shaped areas.

19. The apparatus as claimed in claim 6, wherein the surface structures are linearly shaped and areas separated from another by an intermediary surface are delimited by these structures.

20. The apparatus as claimed in claim 7, wherein the surface structures are linearly shaped and areas separated from another by an intermediary surface are delimited by these structures.
